(19) United States
(12) Patent Application Publication
(10) Pub. No.: US 2008/0283670 A1
(43) Pub. Date: Nov. 20, 2008

(54) K-truss deployable boom system

(76) Inventors: Thomas Jeffrey Harvey, Nederland, CO (US); Toby Justin Harvey, Nederland, CO (US); Jason Hinkle, Superior, CO (US); Shane Stamm, Boulder, CO (US); Eric Ruhl, Broomfield, CO (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/001,081

(22) Filed: Dec. 6, 2007

Related U.S. Application Data
(60) Provisional application No. 60/874,871, filed on Dec. 13, 2006.
(60) Provisional application No. 60/967,159, filed on Aug. 30, 2007.

(51) Int. Cl. B64G 1/66

(52) U.S. Cl. 244/172.6

(57) ABSTRACT

An outer space deployable boom system is formed of a plurality of interconnected longeron members that are linked by diagonal members and batten frames. The diagonal members are arranged in a unique K-type configuration that provides a predictable and orderly folding dynamic as the boom system transitions from a stowed state to a deployed state.

### REFERENCE TO PRIORITY DOCUMENT

This application claims priority of U.S. Provisional Patent Application Ser. No. 60/874,871, filed Dec. 13, 2006 and U.S. Provisional Patent Application Ser. No. 60/967,159, filed Aug. 30, 2007. Priority of the aforementioned filing dates is hereby claimed and the disclosures of the Provisional Patent Applications are hereby incorporated by reference in its entirety.

### STATEMENT OF GOVERNMENT RIGHTS

This invention was made with U.S. Government support under Contract No. FA945306C0039 (3118). The U.S. Government has certain rights in the invention.

### BACKGROUND

The present disclosure relates in general to space-deployable structures, and is particularly directed to a space-deployable boom structure.

The use of tape type elements to form a truss of an outer space self-deployable boom system has been studied for some time. A significant challenge has been to stow or fold up the members of the self-deployable boom system in an orderly and predictable fashion. Space self-deployable booms typically include a plurality of longerons that are interlinked with diagonal elements. Generally the diagonal elements have been configured in a “zig zag” configuration in the past. Such a configuration unfortunately does not provide a predictable or orderly transition between a stowed state and expanded state of the boom system.

In view of the foregoing, there is a need for an improved outer space self-deployable boom system that transitions between a stowed state and an expanded state in an orderly and predictable manner.

### SUMMARY

Disclosed is an outer space deployable boom system that is formed of a plurality of interconnected longeron members that are linked by diagonal members and batten frames. The diagonal members are arranged in a unique K-type configuration that provides a predictable and orderly folding dynamic as the boom system transitions from a stowed state to a deployed state, as described in detail below. The longerons of the boom system are formed of a plurality of modularly-linked longeron members. The modular aspect of the longeron members permits easy and quick replacement of a portion of the boom system and also permits the use of different materials for different longeron members, though the longeron members could be composed of one continuous tape. This can be used to achieve a desired profile coefficient of thermal expansion (CTE) for the entire boom system by tailoring the CTE of each longeron member in a manner that balances the CTE of the whole boom system.

In one aspect, there is disclosed a spacecraft boom system, comprising: at least one bay formed by a pair of opposed battens that are longitudinally interconnected by opposed longeron structures such that the longeron structures and the battens connect at four corners of a side of the bay; a first diagonal member having a first end connected to a first corner of the bay and a second end connected to a longeron structure opposite the first corner of the bay but not located at any corner of the bay; a second diagonal member having a first end connected to a second corner of the bay opposite the first corner and a second end connected to the same longeron structure as the second end of the first diagonal member, wherein the second end of the second diagonal member is not located at any corner of the bay; wherein the boom system is adapted to transition from a collapsed, stowable configuration to an elongated configuration.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows an exemplary embodiment of a three-dimensional deployable boom system in a deployed state.

FIG. 2 shows an enlarged portion of the boom system.

FIG. 3A shows the boom system in a stowed state.

FIG. 3B shows a partial view of longeron members and diagonal members in the stowed or folded state.

FIG. 3C shows a partial view of the longeron members and the diagonal members of FIG. 3B in the unfolded or deployed state.

FIG. 3D shows a top view of the system in the stowed or folded state.

FIG. 4 shows a perspective view of a bay of the boom system.

FIG. 5 shows a side view of a bay of the boom system.

FIG. 6 shows a cross-sectional view of a first longeron member of the boom system.

FIG. 7 shows a cross-sectional view of a second longeron member of the boom system.

### DETAILED DESCRIPTION

Disclosed is an outer space deployable boom system that is formed of a plurality of interconnected longeron members that are linked by diagonal members and batten frames. The diagonal members are arranged in a unique K-type configuration that provides a predictable and orderly folding dynamic as the boom system transitions from a stowed state to a deployed state, as described in detail below. In this regard, the disclosed boom system has purely axial expansion kinematics along the longitudinal axis of the system. The design does not rotate or “ratchet” back and forth about the primary deployment axis (the longitudinal axis). It is a purely axial expansion. The disclosed embodiment has relevant shear and torsion stiffness during deployment which significantly improves predictability, despite still exhibiting low out-of-plane rotational (gimbal) stiffness.

The longerons of the boom system are formed of a plurality of modularly-linked longeron members. The modular aspect of the longeron members permits easy and quick replacement of a portion of the boom system and also permits the use of different materials for different longeron members, though the longeron members could be composed of one continuous tape. This can be used to achieve a desired profile coefficient of thermal expansion (CTE) for the entire boom system by tailoring the CTE of each longeron member in a manner that balances the CTE of the whole boom system. The foregoing is described in more detail below.

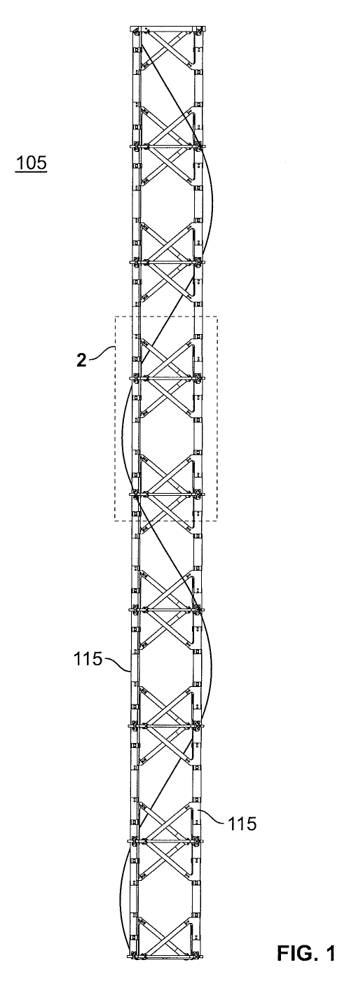

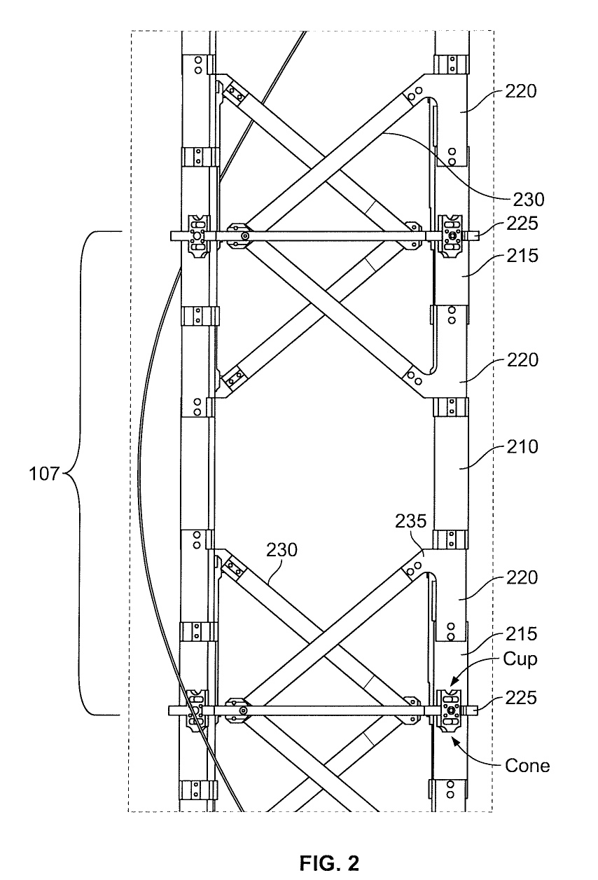

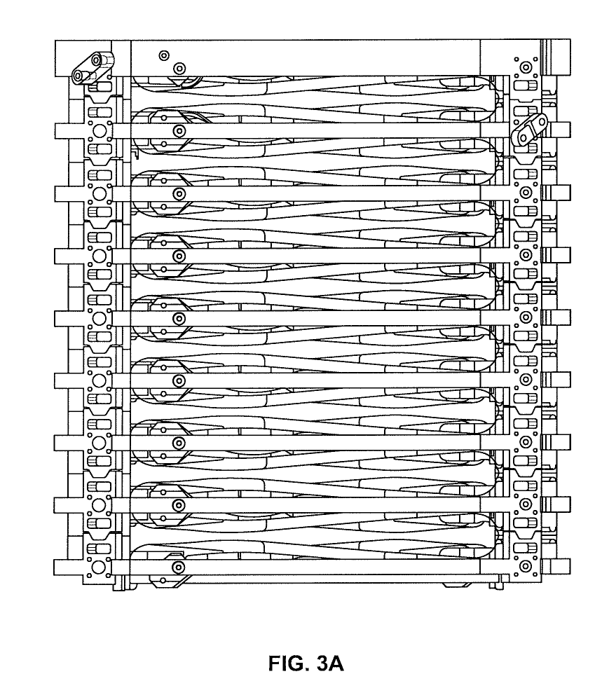

FIG. 1 shows an exemplary embodiment of a three-dimensional deployable boom system 105 in a deployed state. FIG. 2 shows an enlarged portion of the boom system 105. The structural details of a single bay of the boom system 105 can be seen in FIG. 2. The boom system 105 is adapted to transition between a deployed state and a stowed state. In the deployed state (shown in FIG. 1), the boom system 105 is enlarged relative to the stowed state (shown in FIG. 3) wherein the boom system is folded to a smaller size relative to the deployed state. The system transitions from the deployed state to the stowed state by bending of the longeron members and corresponding diagonal members that form the boom system. This is shown in more detail with reference to FIG. 3B, which shows a partial view of include a mid-span longeron member 210, a pair of batten longeron members 215, a pair of diagonal-longeron fitting members 220, and a pair of diagonal members 230 in the stowed or folded state. FIG. 3C shows a partial view of the longeron members and the diagonal members of FIG. 3B in the unfolded or deployed state

The boom system 105 includes a plurality of bays that are structurally and sequentially coupled to one another along the length of the boom system 105. It should be appreciated that the boom system 105 can include any number of bays. Furthermore, the boom system 105 may self-extend into a variety of shapes that include, but are not limited to, a linear shape, an elongated planer shape, and a non-elongated planer shape. Consequently, the boom system 105 is able to support and extend a plurality of components that may include, for example, a solar array assembly, an antenna array assembly, a quadrifilar antenna, or various other structures. Some exemplary shapes are described herein.

Moreover, it should be appreciated that the system is not limited to the specific embodiment shown in the figures. For example, any of the longitudinal or diagonal members can be a rigid element over a portion of its length with a discrete hinge element at either end that joins to the batten frame. This would make the entire structure a collection of rigid elements connected by discrete, localized hinges.

With reference to FIG. 1, the boom system 105 is partially formed of interconnected longeron structures 115 that extend longitudinally along the boom system 105. As shown in the enlarged view of FIG. 2, the longeron structures are formed of a plurality of interconnected longeron members that collectively form a bay. As mentioned, the longeron members are adapted to fold and unfold along their length to permit the boom system to transition between the deployed and stowed states. In an embodiment, the longeron members are each formed of an elongated tape material that conforms to a radius of curvature, as described in detail below. The tape material provides advantageous structural and dynamic capabilities for the boom system. Alternately, the longeron members can be formed of any material or can have any configuration that is suited for use in a boom system. Diagonal members of the boom system, which are described below, can also be formed of tape material.

In the illustrated embodiment shown FIG. 2, a bay of the boom system is formed of a plurality of sequentially-connected longeron members positioned between opposed batten frames. For each bay, the longeron members include a mid-span longeron member 210, a pair of batten longeron member 215, and a pair of diagonal-longeron fitting member 220. The longeron members are modularly connected to one another along their length in a manner that permits quick and easy replacement of a portion of the boom system should one of the longeron members become damaged, as described more fully below. As shown in FIG. 2, each longeron member is attached at one or both ends to an adjacent longeron member. The attachment between the longeron members can be achieved in various manners, including screws, tape, bolts, or any other attachment means.

With reference still to FIG. 2, each bay is further formed of two or more battens wherein the battens collectively form opposed batten frames 225 for each of the bays 107. In addition, the bays each include flexible diagonal members 230, which diagonally interconnect longeron members of a bay to a batten frame. The bays are sequentially interconnected with one another by means of the longeron members, which are foldable between successive batten frames 225 of the system 105. When folded, the system is in a compacted or stowed state as shown in FIG. 3A.

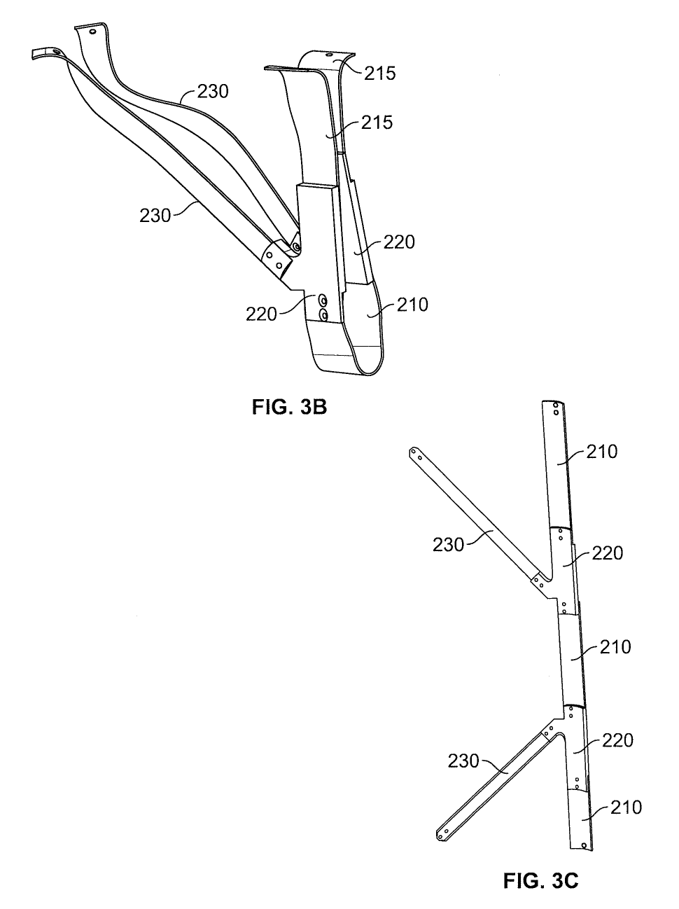

The structural configuration of a single bay is now described with reference again to FIG. 2 and also to FIG. 4, which shows a perspective view of a bay of the boom system 105. The system shown in FIG. 4 is four-sided with the longeron members defining the corner of each side. It should be appreciated that the boom system or a bay of the system can have less than or more than four sides such that the system is triangular or polygonal in cross-section. As mentioned, each bay is bordered on opposed ends by a batten frame 225. Each batten frame 225 has a collection of interconnected battens that define the cross-sectional shape of the boom system.

With reference still to FIGS. 2 and 4, the corner of each batten frame 225 interconnects with a batten longeron member 215 that extends longitudinally along either side of the batten frame 225. Each batten longeron member 215 extends through a corner fitting member 405 (FIG. 4) that interconnects the batten longeron member 215 with a respective corner of the batten frame 225. The corner fitting members 405 can be manufactured of a rigid material, such as a material that is more rigid than the material of the longeron members. This permits one or more secondary structures, such as an antenna, to be rigidly attached to the boom system 105.

The opposite ends of each batten longeron member 215 are connected to a respective diagonal-longeron fitting member 220 that provides a connection to a diagonal member 230. In this regard, each diagonal-longeron fitting member 220 has a diagonally-extending connector 235 (FIG. 2) that provides a means of connection with a respective diagonal member 230. Finally, each bay has a plurality of mid-span longeron members 210 that interconnect the diagonal-longeron fitting members 220 to one another. The mid-span longeron members are positioned midway between the opposed batten frames 225 of each bay.

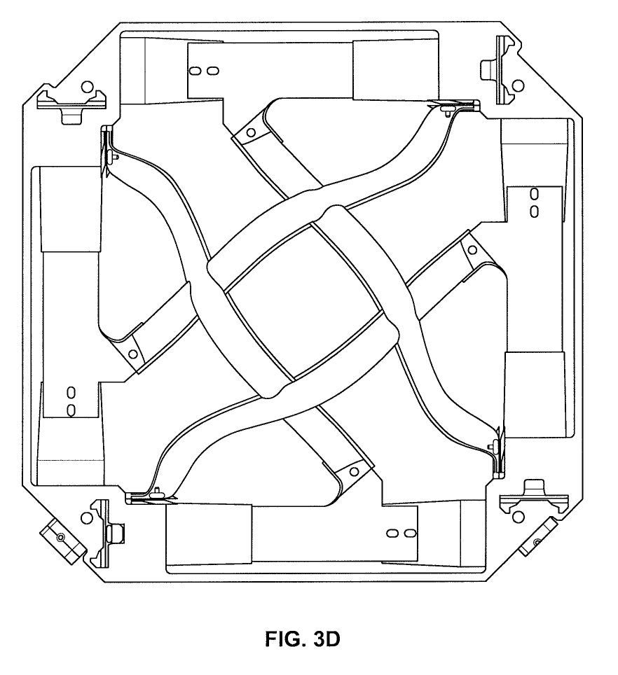

The diagonal members 230 are connected to the longeron members and to the batten frames in a unique manner that provides predictable and orderly folding and unfolding of the boom system 105. This is described in more detail with reference to FIG. 5, which shows a side view of a single bay of the boom system 105. A pair of exemplary diagonal members 230a and 230b are highlighted in FIG. 5 for describing the diagonal configuration, which can be repeated on each side of each bay of the boom system. A first end of the diagonal member 230a connects to an upper batten frame 225a at a connection location 505, which is at or near the corner connection between the batten frame 225a and the batten longeron member 215a. A second end of the diagonal members 230a connects to the diagonal-longeron fitting member 220a at a connection location 510 opposite the corner where the first end is connected. Note that the connection location 510 is upwardly offset from the mid-way location 515 of the bay. The connection location 510 can be positioned at the mid-way location or it can be offset a variety of distances, such as is shown in FIG. 5.

In a similar manner, a first end of the diagonal member 230b connects to a lower batten frame 225b at a connection location 515, which is near the corner connection between the batten frame 225b and the batten longeron member 215b. A second end of the diagonal members 230b connects to the diagonal-longeron fitting member 220b at a connection location 520 opposite the corner where the first end is connected. Note that the connection location 520 is downwardly offset from the mid-way location 515 of the bay. The connection location 520 can be positioned at the mid-way location or it can be offset a variety of distances, such as is shown in FIG. 5. The connection locations 510 and 520 can be positioned at the same or substantially same location such that the two diagonal members 230a and 230b both extend outward toward the opposite corner from the same location.

The diagonal members 230 thus form a K-shaped configuration looking toward a side of the bay system 105, as shown in FIG. 3C. Each side of the bay system 105 can have similar or substantially similar diagonal member configurations. The K-shaped configuration of the diagonal members 230 differs from conventional boom systems wherein the diagonal members extend from one corner of a bay to an opposite corner of a bay. The K-shaped diagonal configuration of the diagonal members 230 provides torsional stabilization to the longeron members to which they are attached, which translates into torsional stability for the entire boom system 105. In addition, the K-shaped diagonal configuration causes the longeron members and the diagonal members to deploy or retract each bay of the system in a non-twisting fashion. This is at least partially the result of the longeron members and diagonal members moving and folding in an orderly V folding pattern as the bay deploys or retracts. The predictable and constrained folding and unfolding advantageously provides a predictable and controllable stress to the hinge elements that may be present on the longeron members and diagonal members. FIG. 3D shows a top view of the system in the stowed or folded state. This illustrates how the “K” is folded at its mid-section to form two co-aligning “V's” in the stowed configuration. It also shows the clean, orderly, and predictable stowed orientation that results from the K configuration.

As mentioned, the interconnected longeron members provide the boom system 105 with a modular configuration. The various longeron members are consecutively and removably attached to one another along their lengths such that the end of one longeron member is attached to an end of a successive, adjacent longeron member. The means of attachment can vary. For example, a hinge structure can be used to attach the longeron members to one another to permit a predetermined movement therebetween, such as to encourage folding of the longeron members relative to one another. Alternately, screws, bolts, staples, or any other attachment means can be used to attach the longeron members to one another. It should be appreciated that the modular aspect of the boom system does not necessarily have to be employed in combination with the K-shaped configuration of the diagonal members. Each can be employed independently or in combination with the other in a boom system.

The modular configuration of the interconnected longeron members has several advantages. For example, the modular configuration permits localized repair of a portion of the boom system 105 should the portion of the boom system become damaged. With reference again to FIG. 4, assume that one or more of the longeron members is damaged and in need repair (identified as “in need of repair” in FIG. 4). In such a case, one or more of the damaged longeron members can be detached from the adjacent longeron member due to the modular connection between the longeron members. A new longeron member is then used to replace the detached longeron member thereby allowing localized repair and/or replacement of a section of the boom system 105.

Another advantage of the modular configuration of the modular longeron members is that it permits localized tuning of the coefficient of thermal expansion (CTE) of the boom system 105. Each longeron member can be made of a material that has a predetermined CTE with the CTEs varying based on a desired profile of thermal expansion for the boom system as a whole. The longeron members can be made of various materials with different CTEs to enable the collective CTE of the boom system to balance or to differ in a predetermined manner. This can provide dimensional stability to the boom system.

The longeron members can be manufactured of various materials. In one embodiment, the longeron members are manufactured of fiber-reinforced polymers although it should be appreciated that the material can vary. In an embodiment, the CTE of a particular longeron member is in the range of −1 μin/in-K to +10 μin/in-K. although the CTE can vary.

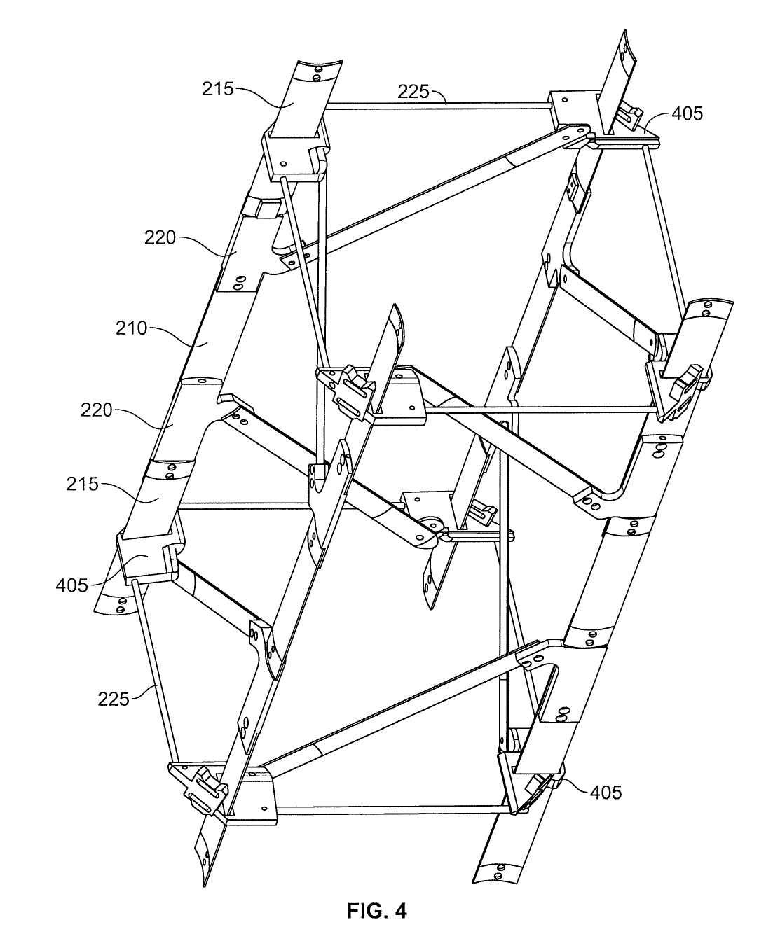

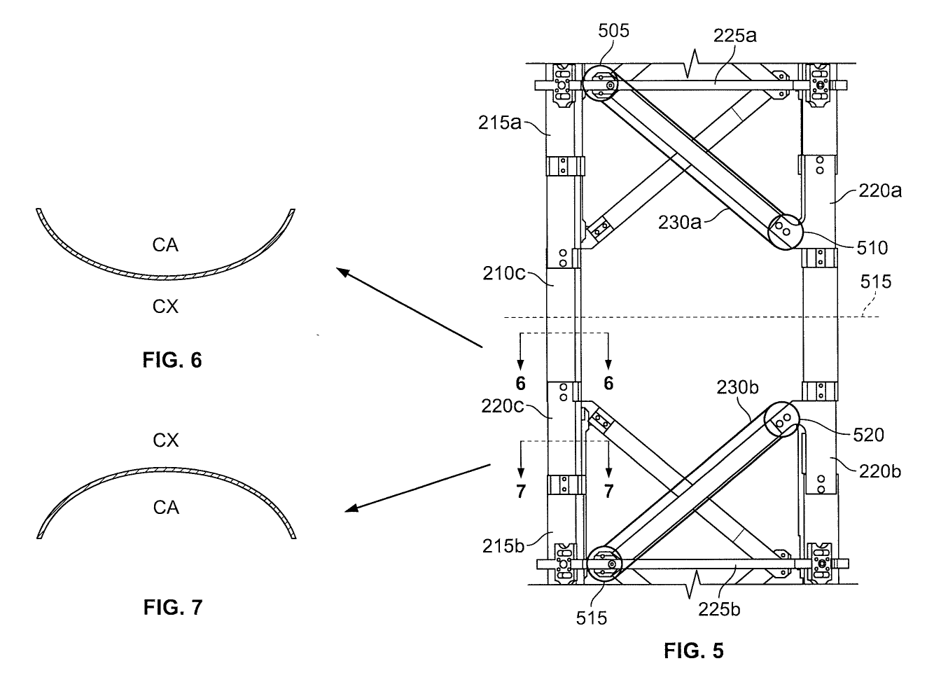

As mentioned, the longeron members can have a curved cross-sectional shape. This is described in more detail with reference to FIG. 6, which shows a schematic cross-sectional view of an exemplary longeron member 210c along line 6-6 of FIG. 5. The cross-sectional view of FIG. 5 is merely schematic and does not show structural details, such as thickness and surface contour, of the longeron member. Note that the longeron member has a curvature with a concave side CA and a convex side CX. The longeron member is more inclined to bend into or toward the concave side CA than into or toward the convex side CX due to the curvature. The hinge that connects the longeron members stores more energy when folded against the curvature than it does when folded with the curvature. The modular approach allows utilization of the most efficient convex-concave orientation at each hinge location, despite the opposing bend direction from one hinge to the next. It should be appreciated that the curvature of the longeron member in FIG. 6 is not to scale and that the actual curvature of the longeron member can vary.

In an embodiment, the orientation of the curvature of the longeron members alternates between consecutive longeron members. Thus, a first longeron member may have a convex side that points in a first direction. The next consecutive longeron member may have a convex side that points in the opposite direction. In this manner, the orientation of the longeron members alternates or flip-flops moving consecutively along the longeron members that are positioned along the length of an entire longeron structure 115 of the boom system 105.

For example, as shown in FIG. 6, a first longeron member 210c has a convex side CX that points in a first direction. The longeron member 220c that is attached to longeron member 210c has a convex side CX that points in the opposite direction from the longeron member 220c. The alternating orientation of curvature of successive longeron members provides a strong and effective deployment force of the boom system as it transitions from the stowed state to the deployed state. The curvature of the longeron members does not necessarily alternate between successive longeron members. It can alternate between groups of longeron members or it can alternate in a non-repeating manner. For example, two successive longeron members can have the convex side pointing in a common direction, while the next three longeron members have the convex side pointing in an opposite direction. The arrangement of the curvature of the longeron members can be varied to provide a desired deployment profile for different sections of the boom system.

With reference again to FIG. 3A, the batten frames can be configured to provide a stable interface therebetween when the boom system is in the folded state. For example, the batten frames can mate with one another in a cup-cone interface manner. This configuration provides a stiff and strong launch load path for the boom system when the cup cones are loaded by an external compressive load. The cup and cone configuration of the batten frames can also be seen in FIG. 2 with the system in the deployed state. It should be appreciated that, as with other features described herein, the cup-cone configuration can vary in structure, size, and shape and that it is not limited to the specific embodiment shown in the figures.

The predictability in folding/unfolding provided by the K-configuration is particularly suited for self-deployable structures that deploy without a secondary motorized system to aid or cause deployment. Previous designs exhibit very low stiffness in essentially every degree of freedom, which causes predictability concerns and chaotic deployment behavior. The disclosed boom system can optionally be used in conjunction with various mechanical and/or electro-mechanical systems to transition the boom system from the stowed state to the deployed state. In an exemplary embodiment, the truss boom system employs a jack screw or elevator screw system for deployment from the stowed to the deployed state. An exemplary elevator screw system is described in U.S. Pat. No. 6,970,143, which is incorporated herein by reference in its entirety.

Although embodiments of various methods and devices are described herein in detail with reference to certain versions, it should be appreciated that other versions, embodiments, methods of use, and combinations thereof are also possible. Therefore the spirit and endoscope of the appended claims should not be limited to the description of the embodiments contained herein.

What is claimed:

1. A spacecraft boom system, comprising:
at least one bay formed by a pair of opposed battens that are longitudinally interconnected by opposed longeron structures such that the longeron structures and the battens connect at four corners of a side of the bay;
a first diagonal member having a first end connected to a first corner of the bay and a second end connected to a longeron structure opposite the first corner of the bay but not located at any corner of the bay;
a second diagonal member having a first end connected to a second corner of the bay opposite the first corner and a second end connected to the same longeron structure as the second end of the first diagonal member, wherein the second end of the second diagonal member is not located at any corner of the bay;
wherein the boom system is adapted to transition from a collapsed, stowable configuration to an elongated configuration.

2. A boom system as in claim 1, wherein the boom system transitions from the stowable configuration to the elongated configuration by unfolding of the longeron structures and diagonal members, and wherein the transition occurs in an orderly and predictable manner.

3. A boom system as defined in claim 1, wherein the boom system includes a plurality of bays interconnected to one another.

4. A boom system as defined in claim 1, wherein each bay has at least three sides.

5. A boom system as in claim 1, wherein each bay has at least four sides.

6. A boom system as in claim 1, wherein the longeron structures are formed of a plurality of elongated longeron members that are sequentially connected to one another in an end-to-end manner.

7. A boom system as in claim 6, wherein the longeron and diagonal members are removably connected to one another in a modular fashion such that a longeron or diagonal member can be detached from the boom system.

8. A boom system as in claim 6, wherein at least two of the longeron members have coefficients of thermal expansion that differ from one another.

9. A boom system as in claim 1, wherein the longeron structures are formed of tape.

10. A boom system as in claim 1, wherein the longeron structures are formed of a plurality of connected longeron members, and wherein each longeron member has a convex side and a convex side.

11. A boom system as in claim 10, wherein the convex side of a first longeron member faces a direction opposite the convex side of a second longeron member connected to the first longeron member.

12. A boom system as in claim 3, wherein at least two of the bays are interconnected via a cup-cone interface.

13. A boom system as in claim 1, further comprising a jack screw system adapted to transition the system from the collapsed, stowable configuration to the elongated configuration.

14. A boom system as in claim 1, wherein each bay has only a single side and only two longeron structures.

15. A boom system as in claim 1, wherein the longeron structures are formed of at least one continuously connected longeron member.
